(19) United States
(12) Patent Application Publication
(10) Pub. No.: US 2014/0267434 A1
(43) Pub. Date: Sep. 18, 2014

(54) DISPLAY SYSTEM WITH EXTENDED DISPLAY MECHANISM AND METHOD OF OPERATION THEREOF

(71) Applicant: Samsung Electronics Co., Ltd., Gyeonggi-do (KR)

(72) Inventors: Parker Ralph Kuncl, Los Gatos, CA (US); Dhana Dhanasarnsombat, San Jose, CA (US); Daniela Karin Busse, San Francisco, CA (US)

(21) Appl. No.: 13/936,617

(22) Filed: Jul. 8, 2013

Related U.S. Application Data
(60) Provisional application No. 61/787,942, filed on Mar. 15, 2013.

(51) Int. Cl. G06T 3/40

(52) U.S. Cl. CPC G06T 3/40
USPC 345/660

(57) ABSTRACT

A method of operation of a display system includes: a display interface configured to display an image; a control unit, coupled to the display interface, configured to: determine location parameters around the display interface; and provide an extended image based on the location parameters.

### CROSS-REFERENCE TO RELATED APPLICATION(S)

This application claims the benefit of U.S. Provisional Patent Application Ser. No. 61/787,942 filed Mar. 15, 2013, and the subject matter thereof is incorporated herein by reference thereto.

### TECHNICAL FIELD

An embodiment of the present invention relates generally to a display system, and more particularly to a system for extended display.

### BACKGROUND

Modern consumer and industrial electronics, especially devices such as graphical display systems, televisions, projectors, cellular phones, portable digital assistants, and combination devices, are providing increasing levels of functionality to support modern life including three-dimensional display services. Research and development in the existing technologies can take a myriad of different directions.

In recent years, consumer and industrial electronic devices have evolved from offering basic services to offering a wide range of communication, data, and other services. For example, these devices can now offer telephony, text messaging, email, calendaring, contacts, user locations, maps, time, cameras, calculators, and internet browsing. To enable interaction with these many new features, devices have also added input controls and output display screens.

The devices are capable of being connected to a number of peripheral devices offering further input controls and output displays. For example, these devices can often be connected to input components such as keyboards, mice, etc. that can control networking, programming, displays, or combination thereof. Output to a primary display screen have increased in size and optimized for intended programming.

As simultaneous interaction with these many new features increases in desirability, limitations on components performance are exacerbated. Many of the components were designed for limited specific purposes and are sub-optimal for many of the new features. Since many of these new features were unanticipated, the design and implementation of the components were never intended to support the desired performance.

Thus, a need still remains for a display system with extended display mechanism. In view of the ever-increasing commercial competitive pressures, along with growing consumer expectations and the diminishing opportunities for meaningful product differentiation in the marketplace, it is increasingly critical that answers be found to these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### SUMMARY

An embodiment of the present invention provides a display system including: a display interface configured to display an image; a control unit, coupled to the display interface, configured to: determine location parameters around the display interface; and provide an extended image based on the location parameters.

An embodiment of the present invention provides a method of operation of a display system including: displaying an image on a display device with a display interface; determining location parameters around the display interface; and providing an extended image based on the location parameters.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is a display system with image conversion mechanism in an embodiment of the present invention.

FIG. 2 is an example of a display interface of the first device of FIG. 1 in an embodiment of the present invention.

FIG. 3 is an exemplary block diagram of the display system.

FIG. 4 is a display system in an embodiment of the present invention.

FIG. 5 is a display system in an embodiment of the present invention.

FIG. 6 is a display system in an embodiment of the present invention.

FIG. 7 is a display system in an embodiment of the present invention.

FIG. 8 is a display system in an embodiment of the present invention.

FIG. 9 is a display system in an embodiment of the present invention.

FIG. 10 is a flow chart of a method of operation of a display system in an embodiment of the present invention.

### DETAILED DESCRIPTION

An embodiment of the present invention includes a display system with a display interface of a first device that can provide a substantially full screen of the image of a game, an event, a show, or a program, with a first extended image and a second extended image adjacent and outside extents of the display interface.

The display system can include pico-extended augmented information extending displays on surfaces with auto-obstacle detection for audio-visual products. Primary display screens can be limited to placement and amount of data that can be shown on the primary screen and/or overlayed on broadcasted content. Also, the display system follows multiple games, events, or shows at once. Channel changing is cumbersome and hard to track what has just happened on another channel.

Consumer and industrial electronic devices can often be connected to keyboards, mice, etc. These devices can also be connected to peripheral projector or display units. The projector units, which are typically large, are designed to be placed on a surface and project an image or other content on a wall that is oblique to the surface or, depending on configuration of the optics of the projector, on the surface itself.

Projection on the surface, however, includes the projector unit located sufficiently distant from the surface. Such distances are often commensurate with the height of the projection unit. Projection on the surface by an adjacent projector unit typically results in substantial image degradation, including distortion artifacts such as keystone, variable focus, and blur of the extended content.

The following embodiments are described in sufficient detail to enable those skilled in the art to make and use the invention. It is to be understood that other embodiments would be evident based on the present disclosure, and that system, process, or mechanical changes may be made without departing from the scope of an embodiment of the present invention.

In the following description, numerous specific details are given to provide a thorough understanding of the invention. However, it will be apparent that the invention may be practiced without these specific details. In order to avoid obscuring an embodiment of the present invention, some well-known circuits, system configurations, and process steps are not disclosed in detail.

The drawings showing embodiments of the system are semi-diagrammatic, and not to scale and, particularly, some of the dimensions are for the clarity of presentation and are shown exaggerated in the drawing figures. Similarly, although the views in the drawings for ease of description generally show similar orientations, this depiction in the figures is arbitrary for the most part. Generally, the invention can be operated in any orientation. The embodiments have been numbered first embodiment, second embodiment, etc. as a matter of descriptive convenience and are not intended to have any other significance or provide limitations for an embodiment of the present invention.

The term “image” referred to herein can include a two-dimensional image, three-dimensional image, video frame, a computer file representation, an image from a camera, a video frame, or a combination thereof. For example, the image can be a machine readable digital file, a physical photograph, a digital photograph, a motion picture frame, a video frame, an x-ray image, a scanned image, or a combination thereof.

The term “module” referred to herein can include software, hardware, or a combination thereof in an embodiment of the present invention in accordance with the context in which the term is used. For example, the software can be machine code, firmware, embedded code, and application software. Also for example, the hardware can be circuitry, processor, computer, integrated circuit, integrated circuit cores, a pressure sensor, an inertial sensor, a microelectromechanical system (MEMS), passive devices, or a combination thereof.

Referring now to FIG. 1, therein is shown a display system 100 with image conversion mechanism in an embodiment of the present invention. The display system 100 includes a first device 102, such as a client or a server, connected to a second device 106, such as a client or server. The first device 102 can communicate with the second device 106 with a communication path 104, such as a wireless or wired network.

For example, the first device 102 can be of any of a variety of display devices, such as a cellular phone, personal digital assistant, a notebook computer, a liquid crystal display (LCD) system, a light emitting diode (LED) system, or other multi-functional display or entertainment device. The first device 102 can couple, either directly or indirectly, to the communication path 104 to communicate with the second device 106 or can be a stand-alone device.

For illustrative purposes, the display system 100 is described with the first device 102 as a display device, although it is understood that the first device 102 can be different types of devices. For example, the first device 102 can also be a device for presenting images or a multi-media presentation. A multi-media presentation can be a presentation including sound, a sequence of streaming images or a video feed, or a combination thereof. As an example, the first device 102 can be a high definition television, a three dimensional television, a computer monitor, a personal digital assistant, a cellular phone, or a multi-media set.

The second device 106 can be any of a variety of centralized or decentralized computing devices, or video transmission devices. For example, the second device 106 can be a multimedia computer, a laptop computer, a desktop computer, a video game console, grid-computing resources, a virtualized computer resource, cloud computing resource, routers, switches, peer-to-peer distributed computing devices, a media playback device, a Digital Video Disk (DVD) player, a three-dimension enabled DVD player, a recording device, such as a camera or video camera, or a combination thereof. In another example, the second device 106 can be a signal receiver for receiving broadcast or live stream signals, such as a television receiver, a cable box, a satellite dish receiver, or a web enabled device.

The second device 106 can be centralized in a single room, distributed across different rooms, distributed across different geographical locations, embedded within a telecommunications network. The second device 106 can couple with the communication path 104 to communicate with the first device 102.

For illustrative purposes, the display system 100 is described with the second device 106 as a computing device, although it is understood that the second device 106 can be different types of devices. Also for illustrative purposes, the display system 100 is shown with the second device 106 and the first device 102 as end points of the communication path 104, although it is understood that the display system 100 can have a different partition between the first device 102, the second device 106, and the communication path 104. For example, the first device 102, the second device 106, or a combination thereof can also function as part of the communication path 104.

The communication path 104 can span and represent a variety of networks. For example, the communication path 104 can include wireless communication, wired communication, optical, ultrasonic, or the combination thereof. Satellite communication, cellular communication, Bluetooth, Infrared Data Association standard (IrDA), wireless fidelity (WiFi), and worldwide interoperability for microwave access (WiMAX) are examples of wireless communication that can be included in the communication path 104. Ethernet, digital subscriber line (DSL), fiber to the home (FTTH), and plain old telephone service (POTS) are examples of wired communication that can be included in the communication path 104. Further, the communication path 104 can traverse a number of network topologies and distances. For example, the communication path 104 can include direct connection, personal area network (PAN), local area network (LAN), metropolitan area network (MAN), wide area network (WAN), or a combination thereof.

Referring now to FIG. 2, therein is shown an example of a display interface 202 in an embodiment of the present invention. The display interface 202 can display an image 204 of a game, an event, a show, or a program in the extents of the display interface 202. The display system 100 can also provide a first extended image 206 and a second extended image 208 outside extents of a display device 210 such as the first device 102 of FIG. 1 or the second device 106 of FIG. 1.

The display device 210 preferably includes the display interface 202, a first projector 212, and a second projector 214 such as a first pico-projector for displaying the first extended image 206 and a second pico-projector for displaying the second extended image 208. The first projector 212 and the second projector 214 can be mounted or enclosed at a back side of the display device 210 opposite the front side having the display interface 202.

The first extended image 206 or the second extended image 208 can include no image such as an empty image. Based on user preferences, event content, program content, show content, game content, or combination thereof, a portion or all of the first extended image 206 or the second extended image 208 can be dark or turned off to enhance or improve a user viewing environment.

The first extended image 206 and the second extended image 208 with extended content, which augments a user environment, can improve game play from attached game consoles such as displaying a dance board for “DanceDanceRevolution”, advertising commercials displaying branded content such as an automaker displaying tire tracks and virtual smoke as a car “burns rubber” and “peels out”, or sporting events on such as golf displaying a simulation of a putting green and locations of various golfers' golf balls.

Entertainment content can also extend beyond the display interface 202 or off screen, such as fireworks, or other actions or actors coming on and moving off the display interface 202 or the primary screen. Content subtraction of moving objects on the display interface 202 can allow for these moving objects or subjects in motion to appear as if they are traveling off the display interface 202 or main primary TV screen and onto the surrounding surfaces around the TV utilizing the first extended image 206 and the second extended image 208. In this way, the images could appear to move off screen in a 3D space and provide a virtual 3D view.

Similarly, an event, program, show, or game broadcast with a super-wide-formatted content stream such as 24×9 instead of 16×9, can extend the event, program, show, or game image wider than the display interface 202 or the main display with projectors such as the first projector 212 and the second projector 214. The projectors can be on sides of the display device 210 to project a wider image than the display interface 202.

The display device 210 such as a TV can also include a docking port or station, through which a tablet or other small mobile device, such as the first device 102 of FIG. 1, can provide an additional screen particularly if a desired surface is not available for additional extended images or content. The user interface (UI) associated with this additional screen can change, including font size or graphics, to compensate for a viewing distance different from a typical viewing distance based on a hand-held position.

The tablet or the other small mobile device providing the additional screen, such as a wireless docked mobile display, can be disconnected or removed and continue to display content such as the first extended image 206 and the second extended image 208 associated with the display device 210 or controlled by the display system 100 such as the TV.

The display device 210 such as the TV can determine or orchestrate on which of the devices to display or show a particular content such as the first extended image 206 and the second extended image 208 based on a placement in the room or other device specific criteria. The display device 210 preferably includes information for coordinating content with various devices and associated locations. For example, the display system 100 can determine display content based on changes in location including distance from the display device 210.

The display content such as the first extended image 206 and the second extended image 208 can also be synchronized with audio including multi-channel audio to further enhance the 3-dimensional quality of an extended viewing experience. Audio content happening off the primary screen can correlate or map to content in the extended display areas such as the first extended image 206 and the second extended image 208.

Audio can also be localized to a specific device, display, screen, side of a device, or combination thereof. For example, if a right side of the display device 210, such as a TV, displays content on a right side wall surface, the audio associated with the specific device or user interface (UI) on the right side can be localized to sound as if it emanated from that specific device or screen.

For example, the first extended image 206 such as a score indicated by the number “45” points can be displayed using a colored light or a dark number with a colored background, such as a red light or background representing a home team color. In a similar manner, the second extended image 208 such as a score indicated by the number “13” can be displayed using a colored light or a dark number with a colored background, such as a yellow light or background representing a visitor team color.

Participants 216 of the display system 100 can view an event, program, show, or game with a substantially full screen with more event, program, show, or game relevant information on-screen and also view related information using an easily readable large font in the first extended image 206 and the second extended image 208 adjacent the display interface 202. This provides an unobstructed view of a currently displayed event, program, show, or game as well as additional extended images for large images that may be relevant to the currently displayed event, program, show, or game.

Further for example, the first extended image 206 or the second extended image 208 can display content and information relevant to other event, program, show, or game content not currently displayed on the display interface 202 such as a primary screen. The first extended image 206 or the second extended image 208 can additional large images that may be unrelated, or irrelevant to the currently displayed event, program, show, or game.

Yet further for example, the first extended image 206 or the second extended image 208 can display branded content and information that may or may not augment what is shown on the display interface 202 such as the primary screen. Preferably based on user preferences, the branded, commercial, or advertisement content can be provided by the first extended image 206 or the second extended image 208 whether related or unrelated to the currently displayed event, program, show, or game.

Yet further for example, the first extended image 206 or the second extended image 208 can display important or breaking news and information. Preferably based on user preferences, the important or breaking news and information content can be provided by the first extended image 206 or the second extended image 208 whether related or unrelated to the currently displayed event, program, show, or game.

For illustrative purposes the first extended image 206 and the second extended image 208 are shown positioned on a right side of the display interface 202 and a left side of the display interface 202 although it is understood that any number or position of extended images such as the first extended image 206 and the second extended image 208 may be used.

Further for illustrative purposes the first projector 212 and the second projector 214 are shown on a right side of the display interface 202 and on a left side of the display interface 202 although it is understood that any number, position, location, or combination of projectors may be used.

Yet further for illustrative purposes, the display device 210 is shown providing the first extended image 206, the second extended image 208, the first projector 212, and the second projector 214, although it is understood the first extended image 206, the second extended image 208, first projector 212, the second projector 214, or combination thereof can be implemented by another of the display device 210.

It has been discovered that the display system 100 with the display interface 202 of the first device 102 can provide a substantially full screen of the image 204 of a game, an event, a show, or a program, with the first extended image 206 and the second extended image 208 adjacent and outside the extents of the display interface 202.

Referring now to FIG. 3, therein is shown an exemplary block diagram of the display system 100. The display system 100 can include the first device 102, the communication path 104, and the second device 106. The first device 102 can send information in a first device transmission 308 over the communication path 104 to the second device 106. The second device 106 can send information in a second device transmission 310 over the communication path 104 to the first device 102.

For illustrative purposes, the display system 100 is shown with the first device 102 as a client device, although it is understood that the display system 100 can have the first device 102 as a different type of device. For example, the first device 102 can be a server having a display interface.

Also for illustrative purposes, the display system 100 is shown with the second device 106 as a server, although it is understood that the display system 100 can have the second device 106 as a different type of device. For example, the second device 106 can be a client device.

For brevity of description in this embodiment of the present invention, the first device 102 will be described as a client device and the second device 106 will be described as a server device. The embodiment of the present invention is not limited to this selection for the type of devices. The selection is an example of an embodiment of the present invention.

The first device 102 can include a first control unit 312, a first storage unit 314, a first communication unit 316, and a first user interface 318. The first control unit 312 can include a first control interface 322. The first control unit 312 can execute a first software 326 to provide the intelligence of the display system 100.

The first control unit 312 can be implemented in a number of different manners. For example, the first control unit 312 can be a processor, an application specific integrated circuit (ASIC) an embedded processor, a microprocessor, a hardware control logic, a hardware finite state machine (FSM), a digital signal processor (DSP), or a combination thereof. The first control interface 322 can be used for communication between the first control unit 312 and other functional units in the first device 102. The first control interface 322 can also be used for communication that is external to the first device 102.

The first control interface 322 can receive information from the other functional units or from external sources, or can transmit information to the other functional units or to external destinations. The external sources and the external destinations refer to sources and destinations external to the first device 102.

The first control interface 322 can be implemented in different ways and can include different implementations depending on which functional units or external units are being interfaced with the first control interface 322. For example, the first control interface 322 can be implemented with a pressure sensor, an inertial sensor, a microelectromechanical system (MEMS), optical circuitry, waveguides, wireless circuitry, wireline circuitry, or a combination thereof.

The first storage unit 314 can store the first software 326. The first storage unit 314 can also store the relevant information, such as data representing incoming images, data representing previously presented image, sound files, or a combination thereof.

The first storage unit 314 can be a volatile memory, a nonvolatile memory, an internal memory, an external memory, or a combination thereof. For example, the first storage unit 314 can be a nonvolatile storage such as non-volatile random access memory (NVRAM), Flash memory, disk storage, or a volatile storage such as static random access memory (SRAM).

The first storage unit 314 can include a first storage interface 324. The first storage interface 324 can be used for communication between and other functional units in the first device 102. The first storage interface 324 can also be used for communication that is external to the first device 102.

The first storage interface 324 can receive information from the other functional units or from external sources, or can transmit information to the other functional units or to external destinations. The external sources and the external destinations refer to sources and destinations external to the first device 102.

The first storage interface 324 can include different implementations depending on which functional units or external units are being interfaced with the first storage unit 314. The first storage interface 324 can be implemented with technologies and techniques similar to the implementation of the first control interface 322.

The first communication unit 316 can enable external communication to and from the first device 102. For example, the first communication unit 316 can permit the first device 102 to communicate with the second device 106 of FIG. 1, an attachment, such as a peripheral device or a computer desktop, and the communication path 104.

The first communication unit 316 can also function as a communication hub allowing the first device 102 to function as part of the communication path 104 and not limited to be an end point or terminal unit to the communication path 104. The first communication unit 316 can include active and passive components, such as microelectronics or an antenna, for interaction with the communication path 104.

The first communication unit 316 can include a first communication interface 328. The first communication interface 328 can be used for communication between the first communication unit 316 and other functional units in the first device 102. The first communication interface 328 can receive information from the other functional units or can transmit information to the other functional units.

The first communication interface 328 can include different implementations depending on which functional units are being interfaced with the first communication unit 316. The first communication interface 328 can be implemented with technologies and techniques similar to the implementation of the first control interface 322.

The first user interface 318 allows a user (not shown) to interface and interact with the first device 102. The first user interface 318 can include an input device and an output device. Examples of the input device of the first user interface 318 can include a keypad, a touchpad, soft-keys, a keyboard, a microphone, an infrared sensor for receiving remote signals, or any combination thereof to provide data and communication inputs.

The first user interface 318 can include a first display interface 330. The first display interface 330 can include a display, a projector, a video screen, a speaker, or any combination thereof.

The first control unit 312 can operate the first user interface 318 to display information generated by the display system 100. The first control unit 312 can also execute the first software 326 for the other functions of the display system 100. The first control unit 312 can further execute the first software 326 for interaction with the communication path 104 via the first communication unit 316.

The second device 106 can be optimized for implementing an embodiment of the present invention in a multiple device embodiment with the first device 102. The second device 106 can provide the additional or higher performance processing power compared to the first device 102. The second device 106 can include a second control unit 334, a second communication unit 336, and a second user interface 338.

The second user interface 338 allows a user (not shown) to interface and interact with the second device 106. The second user interface 338 can include an input device and an output device. Examples of the input device of the second user interface 338 can include a keypad, a touchpad, soft-keys, a keyboard, a microphone, or any combination thereof to provide data and communication inputs. Examples of the output device of the second user interface 338 can include a second display interface 340. The second display interface 340 can include a display, a projector, a video screen, a speaker, or any combination thereof.

The second control unit 334 can execute a second software 342 to provide the intelligence of the second device 106 of the display system 100. The second software 342 can operate in conjunction with the first software 326. The second control unit 334 can provide additional performance compared to the first control unit 312.

The second control unit 334 can operate the second user interface 338 to display information. The second control unit 334 can also execute the second software 342 for the other functions of the display system 100, including operating the second communication unit 336 to communicate with the first device 102 over the communication path 104.

The second control unit 334 can be implemented in a number of different manners. For example, the second control unit 334 can be a processor, an embedded processor, a microprocessor, hardware control logic, a hardware finite state machine (FSM), a digital signal processor (DSP), or a combination thereof.

The second control unit 334 can include a second controller interface 344. The second controller interface 344 can be used for communication between the second control unit 334 and other functional units in the second device 106. The second controller interface 344 can also be used for communication that is external to the second device 106.

The second controller interface 344 can receive information from the other functional units or from external sources, or can transmit information to the other functional units or to external destinations. The external sources and the external destinations refer to sources and destinations external to the second device 106.

The second controller interface 344 can be implemented in different ways and can include different implementations depending on which functional units or external units are being interfaced with the second controller interface 344. For example, the second controller interface 344 can be implemented with a pressure sensor, an inertial sensor, a microelectromechanical system (MEMS), optical circuitry, waveguides, wireless circuitry, wireline circuitry, or a combination thereof.

A second storage unit 346 can store the second software 342. The second storage unit 346 can also store the such as data representing incoming images, data representing previously presented image, sound files, or a combination thereof. The second storage unit 346 can be sized to provide the additional storage capacity to supplement the first storage unit 314.

For illustrative purposes, the second storage unit 346 is shown as a single element, although it is understood that the second storage unit 346 can be a distribution of storage elements. Also for illustrative purposes, the display system 100 is shown with the second storage unit 346 as a single hierarchy storage system, although it is understood that the display system 100 can have the second storage unit 346 in a different configuration. For example, the second storage unit 346 can be formed with different storage technologies forming a memory hierarchal system including different levels of caching, main memory, rotating media, or off-line storage.

The second storage unit 346 can be a volatile memory, a nonvolatile memory, an internal memory, an external memory, or a combination thereof. For example, the second storage unit 346 can be a nonvolatile storage such as non-volatile random access memory (NVRAM), Flash memory, disk storage, or a volatile storage such as static random access memory (SRAM).

The second storage unit 346 can include a second storage interface 348. The second storage interface 348 can be used for communication between other functional units in the second device 106. The second storage interface 348 can also be used for communication that is external to the second device 106.

The second storage interface 348 can receive information from the other functional units or from external sources, or can transmit information to the other functional units or to external destinations. The external sources and the external destinations refer to sources and destinations external to the second device 106.

The second storage interface 348 can include different implementations depending on which functional units or external units are being interfaced with the second storage unit 346. The second storage interface 348 can be implemented with technologies and techniques similar to the implementation of the second controller interface 344.

The second communication unit 336 can enable external communication to and from the second device 106. For example, the second communication unit 336 can permit the second device 106 to communicate with the first device 102 over the communication path 104.

The second communication unit 336 can also function as a communication hub allowing the second device 106 to function as part of the communication path 104 and not limited to be an end point or terminal unit to the communication path 104. The second communication unit 336 can include active and passive components, such as microelectronics or an antenna, for interaction with the communication path 104.

The second communication unit 336 can include a second communication interface 350. The second communication interface 350 can be used for communication between the second communication unit 336 and other functional units in the second device 106. The second communication interface 350 can receive information from the other functional units or can transmit information to the other functional units.

The second communication interface 350 can include different implementations depending on which functional units are being interfaced with the second communication unit 336. The second communication interface 350 can be implemented with technologies and techniques similar to the implementation of the second controller interface 344.

The first communication unit 316 can couple with the communication path 104 to send information to the second device 106 in the first device transmission 308. The second device 106 can receive information in the second communication unit 336 from the first device transmission 308 of the communication path 104.

The second communication unit 336 can couple with the communication path 104 to send information to the first device 102 in the second device transmission 310. The first device 102 can receive information in the first communication unit 316 from the second device transmission 310 of the communication path 104. The display system 100 can be executed by the first control unit 312, the second control unit 334, or a combination thereof. For illustrative purposes, the second device 106 is shown with the partition having the second user interface 338, the second storage unit 346, the second control unit 334, and the second communication unit 336, although it is understood that the second device 106 can have a different partition. For example, the second software 342 can be partitioned differently such that some or all of its function can be in the second control unit 334 and the second communication unit 336. Also, the second device 106 can include other functional units not shown in FIG. 3 for clarity.

The functional units in the first device 102 can work individually and independently of the other functional units. The first device 102 can work individually and independently from the second device 106 and the communication path 104.

The functional units in the second device 106 can work individually and independently of the other functional units. The second device 106 can work individually and independently from the first device 102 and the communication path 104.

For illustrative purposes, the display system 100 is described by operation of the first device 102 and the second device 106. It is understood that the first device 102 and the second device 106 can operate any of the modules and functions of the display system 100.

Referring now to FIG. 4, therein is shown a display system 400 in an embodiment of the present invention. The display system 400 can include the first extended image 206, the second extended image 208, an upper extended image 406, and a lower extended image 408 outside the extents of the display interface 202 to provide a substantially full screen of the image 204 of a game, an event, a show, or a program.

For illustrative purposes, the display system 100 is shown having the upper extended image 406 above the display interface 202 such as on a ceiling and the lower extended image 408 below the display interface 202 such as on a floor, although it is understood that the upper extended image 406 and the lower extended image 408 may be in any position with respect to the display interface 202. The terms “upper” and “lower” describing the extended image can refer to positions relative to one another, other of the extended images, the display interface 202, or combination thereof.

The display device 210, such as a wirelessly-connected television set, can project images at different locations in an environment including around and behind the bezel bordering or surrounding the display interface 202 of the display device 210 as well as onto the ceiling and floor while avoiding detected obstacles 410. This extends the viewing experience outside of the main display.

The display device 210 such as a pico-projection enabled consumers television (TV) set provides an improved image at least with the first projector 212 and the second projector 214 such as embedded pico-projectors including optics for focusing and combining images outside edges of the display device 210. The content displayed in the extended images 206, 208, 406, 408 could be relevant or not relevant to the content displayed by the display interface 202.

Using sensors 414 along edges, front, rear, or combination thereof of the display device 210 such as the TV panel, the display system 100 can detect the obstacles 410, such as walls, distances, textures, or combination thereof in order to workaround the obstacles 410 and display a most useful content and best arrangement of a user interface (UI).

The display system 100 with the sensors 414 can scan floors, ceilings, surrounding walls, surfaces, or combination thereof to reorient or alter content or content placement to improve the first extended image 206, the second extended image 208, the upper extended image 406, the lower extended image 408, or combination thereof. The floors, ceilings, surrounding walls, surfaces, surrounding environment, user location, or combination thereof can provide location parameters around the display interface 202 for determining the extended image 206, 208, 406, 408, or combination thereof.

The projectors 212 and 214 can be adjusted to compensate for or to shift extended image colors or scaling to provide idealized colors or scaled images based on surfaces. The object and surface detection for idealized colors or scaling images can include existent walls, non-existent walls, angled walls, walls of varying color, reflectivity, the obstacles 410 on the walls like picture frames and paintings, ambient light level, or combination thereof.

By using object and surface detection, the display system 100 with the sensors 414 can include additional extended images or displays, which improve or augment display content on the display device 210 or the primary screen with additional extended images or content on one or more extended displays or screens. The display system 100 can determine appropriate display images or content for some or all of the display device 210, the first extended image 206, the second extended image 208, the upper extended image 406, the lower extended image 408, or combination thereof.

The one or more extended displays or screens can include mutually controlled space including allowing interaction in one of the display device 210 such as a television to appear or be reflected on another of the display device 210 such as another television. The one or more extended displays or screens such as the display device 210 can display images or content based on predetermined content or information including curated metadata, which can be based on user request, user preferences, sampling in stream data to generate user data, service providers, or combination thereof.

By incorporating multiple surfaces or displays, display images or content can now move appropriately to the best available screen and surface based on user preferences, content producers, available device, available surfaces, or combination thereof. The multiple surfaces or displays can include projected images or supplemental screens for the first extended image 206, the second extended image 208, the upper extended image 406, the lower extended image 408, or combination thereof.

The image 204, the first extended image 206, the second extended image 208, the upper extended image 406, the lower extended image 408, or combination thereof can provide a surround image including a “follow me” image that displays or projects the image based on the participant 216 or user location. The images 204, 206, 208, 406, or 408, can change dynamically based on the participant 216, the surrounding environment, or combination thereof.

For example, during a baseball game, when a user's favorite player comes up to bat, additional information can be extended next to the TV on the surrounding walls, and the strike zone data can be displayed on another of the display device 210 such as a wireless tablet device, the first device 102 of FIG. 1, or the second device 106 of FIG. 1, which can be in the user's hand. If the user docks the another of the display device 210 near the TV or attached to it, the user interface (UI) of the another of the display device 210 can change to display the ball and strike count in a larger display such as a textual display.

Using a sensor 414 such as an image sensor on a front of the display device 210 or a TV along with speech and gesture detection, two users could independently control separate surfaces. For example, user A on a left side of a couch can control a left extended screen, while user B on a right side of the couch can interact and control user interface (UI) elements on a right-most extended surface.

The display device 210 can include the first device 102 including the first control unit 312, the first storage unit 314, the first communication unit 316, the first user interface 318, or combination thereof. The sensors 414, the first projectors 212, the second projectors 214, or combination thereof are preferably coupled to the first control unit 312, the first storage unit 314, the first communication unit 316, the first user interface 318, or combination thereof. Similarly, the display device 210, the sensors 414, the first projectors 212, the second projectors 214, or combination thereof can be implemented with the second device 106.

The first control unit 312 or the second control unit 334 can preferably be coupled to the sensors 414, the first projectors 212, the second projectors 214, or combination thereof to provide the location parameters around the display interface 202, which can also be stored in the first storage unit 315. The first control unit 312, the second control unit 334, the first communication unit 316, the second communication unit 336, the first user interface 318, the second user interface 338, or combination thereof can also provide extended image content to the first projectors 212, the second projectors 214, or combination thereof.

For illustrative purposes first projectors 212 and second projectors 214 are shown as part of the display device 210 although it is understood the first projectors 212 and the second projectors 214 may be stand-alone, embedded in mobile devices such as phones, embedded in glasses, embedded in goggles, an automobile video screen, a heads-up display (HUD), or combination thereof.

It has been discovered that the display system 100 with the sensors 414 provides content displayed appropriate to the best available screen and surface based on user preferences, content producers, available device, available surfaces, or combination thereof. By using object and surface detection, the display system 100 with the sensors 414 can include additional extended images or displays. The display system 100 can determine appropriate display images or content for the display device 210, the first extended image 206, the second extended image 208, the upper extended image 406, the lower extended image 408, or combination thereof.

Referring now to FIG. 5, therein is shown a display system 500 in an embodiment of the present invention. The display system 500 can include an image 504 shown on the display interface 202 of the display device 210 and a block extended image 506. The block extended image 506 can optionally include a first block 508, a second block 510, and a third block 512.

For illustrative purposes the block extended image 506 is shown having three blocks although it is understood that there may be any number, position, or location of the block or blocks.

The block extended image 506 can preferably provide image projections or displays augmenting the image 504 of the content currently on the display device 210 or primary screen.

For example, the first block 508 of the block extended image 506 can include a representation augmenting the image 504 of a first race driver's current position in a particular automobile race currently displayed on the display device 210 or primary screen. The block extended image 506 can also include a current lap number and optionally a sponsor image. Similarly, the second block 510 can include a second race driver's current position, current lap number, and sponsor image. Further the third block 512 can include a current lap number and optionally a sponsor image. Similarly, the second block 510 can include a third race driver's current position, current lap number, and sponsor image.

It has been discovered that the display system 500 with the block extended image 506 can provide unique statistics or results in each block. The block extended image 506 can be a single extended image with individual blocks or multiple extended images with each extended image including one or more blocks.

Referring now to FIG. 6, therein is shown a display system 600 in an embodiment of the present invention. The display system 600 can include an image 604 of the display interface 202 and the block extended image 506. The image 604 represents the content currently on the display device 210 or primary screen.

The block extended image 506 can optionally represent the augmenting content related to the image 504 of FIG. 5 representing the content, which is not currently displayed on the display device 210 or primary screen. The block extended image 506 can include the representations augmenting the image 504 but not the image 604 of the content currently on the display device 210 or primary screen.

For example, a channel of the display device 210 such as a television has been changed to an alternate program or sporting event. However, the block extended image 506 or projections can continue to display or project information regarding the previously watched show, game, or channel to keep a viewer or user current or up to date while watching the alternate program.

It has been discovered that the block extended image 506 or graphic from the projectors 414 of FIG. 4 such as pico-projectors can be synchronized with a program of the display interface 202 such as on the primary screen, or with the alternative program, data stream, or data source not currently shown on the display interface 202 or the primary screen. When a user or the participant 216 of FIG. 2 relinquishes control to another user or participant or decides to watch an entirely different set of content, the user or the participant can still follow along with a previous content such as the image 504 with the previous content represented by the block extended image 506 displayed adjacent or around the display device 210 providing updates.

Referring now to FIG. 7, therein is shown a display system 700 in an embodiment of the present invention. The display system 700 can include an image 704 shown on the display interface 202 of the display device 210 and a block extended image 706. The block extended image 706 can optionally include a first block 708, and a second block 710. For illustrative purposes the block extended image 706 is shown having two blocks although it is understood that there may be any number, position, or location of the block or blocks.

The block extended image 706 can preferably display different or alternate content from the image 704 of the display interface 202. The different or alternate content can be related or relevant to an event, program, show, or game other than an event, program, show, or game represented by the image 704.

For example, a participant such as the participants 216 of FIG. 2 can follow along with updates from one sporting event including scores, game clock, or other event related information represented by images in the first block 708 and updates from another sporting event in the second block 710.

It has been discovered that the display system 700 with the block extended image 706 can provide information such as updates in the first block 708 and additional or different information in the second block 710. These updates can be participant or user configurable and allow tracking or monitoring of multiple events, programs, shows, or games without the need for picture-in-picture displays or multiple displays such as the display interface 202 or the display device 210.

Referring now to FIG. 8, therein is shown a display system 800 in an embodiment of the present invention. The display system 800 can include an image 804 shown on the display interface 202 of the display device 210 and a block extended image 806. For illustrative purposes the block extended image 706 is shown having as one block although it is understood that there may be any number, position, or location of the block or blocks.

The block extended image 806 can preferably display different or alternate content from the image 704 of the display interface 202. The different or alternate content can be related or relevant to an event, program, show, or game other than an event, program, show, or game represented by the image 704.

For example, the different or alternate content of the block extended image 806 can be branded advertisements, promotions and other branded content that can accompany the display interface 202 or the primary screen content at key moments or any other time. The different or alternate content can include additional branding of related products or information related to an advertising commercial currently shown on the display interface 202 or the primary screen.

As another example, different, alternate, or related content of the block extended image 806 can provide contextual information, background information, interesting trivia, or combination thereof to improve or enhance the viewing of the event, program, show, or game. The related content can include production notes, athlete's information, visualizations of data, related statistics, other related information, or combination thereof.

As yet another example, different, alternate or extended content of the block extended image 806 can enhance the viewing of the event, program, show, game, or live program. The extended content can include visualization of cheering during sports events, visualization of cheering during concerts, reactions to a particular scene, reactions to a particular sports play, other program related response, or combination thereof.

It has been discovered that the display system 800 with the block extended image 806 can provide information such as advertisements, program related data, audience responses, or combination thereof. The information can be configured by a participant such as the participants 216 of FIG. 2 or a user and allow an enhanced or improved experience for events, programs, shows, or games without the need for picture-in-picture displays or multiple displays such as the display interface 202 or the display device 210.

Referring now to FIG. 9, therein is shown a display system 900 in an embodiment of the present invention. The display system 900 can include an image 904 shown on the display interface 202 of the display device 210 and a block extended image 906. For illustrative purposes the block extended image 906 is shown having as one block although it is understood that there may be any number, position, or location of the block or blocks.

The block extended image 806 can preferably display related content for the image 904 of the display interface 202. The related content can preferably be relevant to an event, program, show, or game represented by the image 704 to improve, enhance, or augment viewing. The related content can integrate additions or extensions to the image 904 shown on the display interface 202 or primary display integrated with the block extended image 806.

The block extended image 806 can include extended content accompanying the display interface 202 or main primary screen based on a current focused view. The current focused view can be based on a focus or a certain camera angle of the image 904. The current focus view can also include a focus of a participant such as the participants 216 of FIG. 2 or a user based on the sensors 414 of FIG. 4. The first projector 212 or the second projector 214 of FIG. 2 such as a pico-projector provides added detailed information pulled from various data streams for added detail to augment the user's environment.

For example, a “Pitcher Mode” can provide the image 904 of a favorite baseball pitcher throwing a baseball 908 traveling across the block extended image 806 representing a home plate 910 and batter's boxes 912. A participant such as the participants 216 of FIG. 2 or a user can view the extended image of the block extended image 806 that is related to but not part of the program broadcast.

It has been discovered that the display system 900 with the sensors 414, the first projector 212, and the second projector 214 provides the block extended image 806 based on a current focused view of the image 904, the participants 216, or combination thereof. Specifically, the block extended image 806 includes added detailed information pulled from various data streams for added detail to augment the user's environment based on the focused views.

Referring now to FIG. 10, therein is shown a flow chart of a method 1000 of operation of a display system 100 in an embodiment of the present invention. The method 1000 includes: displaying an image on a display device with a display interface in a block 1002; determining location parameters around the display interface in a block 1004; and providing an extended image based on the location parameters in a block 1006.

The display system 100 with extended display mechanism, such as a pico-projection embedded device for augmented information on a peripheral display, can optionally include: a virtual 3D experience, dynamic formatting including workaround of obstacles 410, idealized color based on surfaces, projecting image at different location in environment, or scaling images based on the environment. The display system 100 can further optionally include curated metadata including mutually controlled space that can allow interaction in one television to reflect on another television, sampling in stream data to generate user or own data, supplemental screens, or surround images including follow me image or dynamically present image based on the audience and environment.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization. Another important aspect of an embodiment of the present invention is that it valuably supports and services the historical trend of reducing costs, simplifying systems, and increasing performance.

These and other valuable aspects of an embodiment of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters set forth herein or shown in the accompanying drawings are to be interpreted in an illustrative and non-limiting sense.

What is claimed is:

1. A display system comprising:
a display interface configured to display an image;
a control unit, coupled to the display interface, configured to:
determine location parameters around the display interface; and
provide an extended image based on the location parameters.

2. The system as claimed in claim 1 wherein the control unit is configured to provide the extended image relevant to the image.

3. The system as claimed in claim 1 wherein the control unit is configured to provide the extended image not relevant to the image.

4. The system as claimed in claim 1 wherein the control unit is configured to provide the extended image representing an extension of the image.

5. The system as claimed in claim 1 wherein the control unit is configured to provide the extended image representing an advertisement.

6. The system as claimed in claim 1 wherein the control unit is configured to provide a second extended image on a side of the display interface opposite the extended image.

7. The system as claimed in claim 1 wherein the control unit is configured to provide a second extended image on a floor.

8. The system as claimed in claim 1 wherein the control unit is configured to provide a second extended image on a ceiling.

9. The system as claimed in claim 1 further comprising a projector coupled to the display interface for displaying the extended image.

10. The system as claimed in claim 1 further comprising a sensor coupled to the control unit for determining content of the extended image.

11. A method of operation of a display system comprising:
displaying an image on a display interface;
determining location parameters around the display interface; and
providing an extended image based on the location parameters.

12. The method as claimed in claim 11 wherein providing the extended image based on the location parameter includes providing the extended image including content relevant to the image.

13. The method as claimed in claim 11 wherein providing the extended image based on the location parameter includes providing the extended image including content not relevant to the image.

14. The method as claimed in claim 11 wherein providing the extended image based on the location parameter includes providing the extended image including content extending the image.

15. The method as claimed in claim 11 wherein providing the extended image based on the location parameter includes providing the extended image including an advertisement.

16. The method as claimed in claim 11 further comprising providing a second extended image configured to display on a side of the display interface opposite the extended image.

17. The method as claimed in claim 16 further comprising providing a second extended image configured to display on a floor.

18. The method as claimed in claim 16 further comprising providing a second extended image configured to display on a ceiling.

19. The method as claimed in claim 16 wherein providing the extended image based on the location parameter includes providing the extended image to a projector.

20. The method as claimed in claim 16 wherein determining the location parameters around the display interface includes determining the location parameters around the display interface with a sensor.
